(19) United States
(12) Patent Application Publication
(10) Pub. No.: US 2020/0408205 A1
(43) Pub. Date: Dec. 31, 2020

(54) INFLATION DEVICE FEATURING AUTOMATIC PRESSURE DETECTING, AIR CHARGING, AND PRESSURE RELEASING

(71) Applicant: Dongguan Hesheng Machinery & Electric Co., Ltd., Dongguan (CN)

(72) Inventor: Chi-Wen CHEN, Dongguan (CN)

(21) Appl. No.: 16/454,019

(22) Filed: Jun. 26, 2019

(51) Int. Cl. F04B 49/08; F04B 35/04; F04B 49/06

(52) U.S. Cl. CPC F04B 49/08; G01L 17/00; F04B 49/06; F04B 35/04

(57) ABSTRACT

An inflation device includes an air charging device and an air charging pipeline that includes an air conveyance channel and a first signal transmission line. The air conveyance channel has an air charging end combined with an air nozzle and is provided, on a portion thereof adjacent to the air nozzle, with a pressure transducer. An air entrance end of the air conveyance channel is connected to an air outlet port of the air charging device, and the first signal transmission line is electrically connected to the pressure transducer and a control circuit of the air charging device. The air nozzle is connectable with an inflatable object so that the pressure transducer is located adjacent to the inflatable object. When the pressure transducer detects an internal pressure of the inflatable object adjacent thereto is identical to a predetermined charging level, the air charging device is shut down.

### TECHNICAL FIELD OF THE INVENTION

The present invention relates to an inflation device featuring automatic pressure detecting, air charging, and pressure releasing, and more particularly to one that includes an air charging pipeline arranged at a location adjacent to an inflatable object and provided with a pressure transducer, wherein the air charging pipeline includes both an air conveyance channel and a first signal transmission line to allow the air charging pipeline to connect to and communicate with an air charging device through the air conveyance channel and the first signal transmission line being in electrical connection with the pressure transducer and a control circuit arranged with the air charging device to form electrical connection between the pressure transducer and the control circuit, whereby with the pressure transducer being arranged at a location that is adjacent to (or close to) an inflatable object, pressure data detected by the pressure transducer is closer to an internal pressure of the inflatable object so as to effectively reduce an error between an actual pneumatic pressure of the inflatable object and an output pressure of the air charging device, and also, at the time when the internal pressure of the inflatable object being detected by the pressure transducer to be identical to a predetermined charging level of the air charging device, the operation of the air charging device is shut down, and the air charging device is further provided with a pressure relief device to allow a pressure relief device to be activated to release pressure at the time when the internal pressure of the inflatable object detected by the pressure transducer that is arranged adjacent thereto is greater than the predetermined charging level of the air charging device so that the present invention may achieve perfect operation of automatic pressure detecting, air charging, and pressure releasing.

### DESCRIPTION OF THE PRIOR ART

Air compressors or compact air-charging devices are commonly used with pneumatic tools, vehicle tires, and various inflatable articles to serve as a source of pressurized air or a source of power. Thus, in the field of automobile applications or other fields that users are allowed to work on things by themselves, the air compressors or air-charging devices play an important role of supplying pressurized air for maintaining, repairing, or even improving for applications of automobiles, general working shops, and household things.

An air-charging device is operated by having an internal motor driving a crankshaft that is rotated and causes a piston rod to drive a piston to move reciprocally. This causes periodic change of a volume of a cylinder, such that in a compression stroke, the volume is reduced and air is compressed and forced to pass through a one-way valve (a check valve, for example) and subsequently flow through a flexible tube and a nozzle to charge into and thus inflate an inflatable object.

To avoid events of excessive charging of an inflatable object that may cause explosion or damage of the object, a known air-charging device is provided with a pressure gauge and a pressure sensor. Thus, when the air-charging device is used to charge and inflate an inflatable object (such as a tire) with a predetermined pressure, during the course of air charging, the air-charging device will be shut down once the pressure sensor detects the air pressure that is fed out from the air-charging device reaches a predetermined level (namely a desired charging pressure), so that the inflatable object is prevented from being over pressurized and no excessive charging issue may occur.

The known air-charging device that is provided with a pressure sensor is structured such that the pressure sensor is mounted at an air outlet port of the device. However, the air pressure at the air outlet port of the air-charging device is for sure higher than the internal pressure of the inflatable object (such as a tire) that is being inflated by the air-charging device. Consequently, even when the pressure sensor detects the output pressure fed out from the air-charging device reaches the predetermined level, such a pressure is the pressure at the air outlet port, rather than the actual pressure that is inside the inflatable object. This would leads to an undesired situation that the internal pressure of the inflatable object is lower than the pressure level set up with the pressure gauge and the actual pressure level of the inflatable object may not be sufficient, causing unexpected potential risk of the operation of the inflatable object.

Thus, the primary technical issue that the present invention is made to overcome is to provide a device that is operable to carry out automatic air charging and depressurizing operations in such an accurate and reliable way of charging an inflatable object to a desired pressure level.

### SUMMARY OF THE INVENTION

To overcome the above-discussed problems and shortcomings of the prior art, the present invention provides an inflation device featuring automatic pressure detecting, air charging, and pressure releasing, which comprises an air charging device and at least one air charging pipeline. The air charging device is provided with an air outlet port. The air charging device is provided, in an interior thereof, with a control circuit. The control circuit is operable to set up a predetermined charging level. The air charging pipeline comprises an air conveyance channel and a first signal transmission line. The air conveyance channel has an end that is provided with an air entrance end and an opposite end that is provided with an air charging end. The air entrance end is connected to and in communication with the air outlet port of the air charging device. The air charging end is combined with an air nozzle. The air charging pipeline is provided, on a potion thereof that is adjacent to the air nozzle, with a pressure transducer. The first signal transmission line is in electrical connection with the pressure transducer and a control circuit of the air charging device to form electrical connection between the pressure transducer and the control circuit, so that data detected by the pressure transducer is transmittable through the first signal transmission line to the control circuit and the control circuit determines if the data detected by the pressure transducer reaches the predetermined charging level, and then, the control circuit controls activation/de-activation of the operation of the air charging device.

The technical features of the present invention are that the air charging pipeline is provided, on a portion thereof that is adjacent to an inflatable object, with a pressure transducer, and the air charging pipeline is provided with an air conveyance channel and a first signal transmission line, so that the air charging pipeline is connectable and thus in communication with the air charging device by means of the air conveyance channel and is set in electrical connection with the pressure transducer and the control circuit arranged in the air charging device by means of the first signal transmission line to form electrical connection between the pressure transducer and the control circuit. With such an arrangement, by having the pressure transducer arranged at a location that is adjacent to (or close to) an inflatable object, pressure data detected by the pressure transducer is closer to an actual internal pressure of the inflatable object, and thus effectively reducing a difference or error between the actual pressure of the inflatable object and the output pressure of the air charging device. Further, the operation of the air charging device can be shut down when the pressure transducer detects the internal pressure of the inflatable object adjacent thereto being identical to a predetermined charging level of the air charging device, thereby achieving an automatic charging operation that accurately and reliably reaches the desired pressure necessary for the inflatable object.

Other technical features of the present invention are that the air charging device is provided, on the air outlet port, with a pressure relief device, so that when the internal pressure of the inflatable object detected by the pressure transducer located adjacent thereto is greater than the predetermined charging level of the air charging device, the control circuit arranged on the air charging device activates an operation of the pressure relief device so as to achieve an automatic pressure releasing operation that is necessary for achieving a pneumatic pressure required by the inflatable object.

### BRIEF DESCRIPTION OF THE DRAWINGS

FIG. 1 is a schematic view showing an inflation device featuring automatic pressure detecting, air charging, and pressure releasing according to a first embodiment of the present invention.

FIG. 2 is a schematic view showing an inflation device featuring automatic pressure detecting, air charging, and pressure releasing according to a second embodiment of the present invention.

FIG. 3 is an enlarged view of a circled portion A of FIG. 2.

FIG. 4 is a cross-sectional view taken along line B-B of FIG. 2.

FIG. 5 is a cross-sectional view of a portion of the inflation device featuring automatic pressure detecting, air charging, and pressure releasing according to the second embodiment of the present invention.

FIG. 6 is a schematic view showing an inflation device featuring automatic pressure detecting, air charging, and pressure releasing according to a third embodiment of the present invention.

FIG. 7 is a schematic view showing an inflation device featuring automatic pressure detecting, air charging, and pressure releasing according to a fourth embodiment of the present invention.

FIG. 8 is a schematic view showing an inflation device featuring automatic pressure detecting, air charging, and pressure releasing according to another embodiment of the present invention.

### DETAILED DESCRIPTION OF THE PREFERRED EMBODIMENT

To have other features and advantages of the present invention, and efficacies achieved with the present invention, to be easily understood, the features and advantages of the present invention will be described in detail with reference to drawings that illustrate the present invention and the illustration of embodiments of the present invention made below are provided to explain the aspects of the present invention, but is not intended to constrain, in any way, the scope of the present invention.

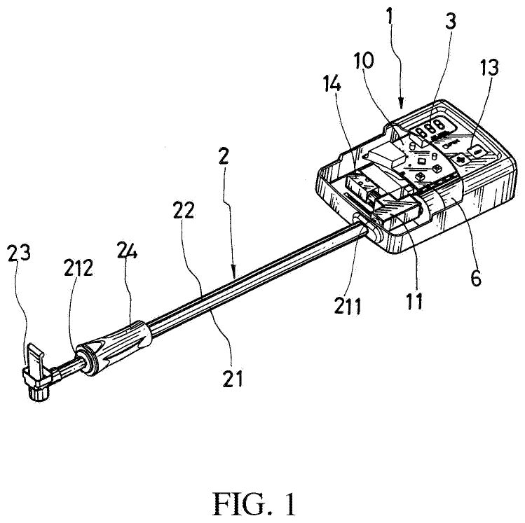

Referring first to FIGS. 1-5, the present invention provides an inflation device that features automatic pressure detecting, air charging, and pressure releasing, comprising an air charging device 1, at least one air charging pipeline 2, and a display device 3.

The air charging device 1 is provided with an air outlet port 11. The air charging device 1 is provided, in an interior thereof, with a control circuit 10. The control circuit 10 is operable to set up a predetermined charging level. Further, the air charging device 1 is provided with a control switch 12 and a plurality of control buttons 13. The control switch 12 and the plurality of control buttons 13 are in electrical connection with the control circuit 10, and the control switch 12 is operable to control activation and de-activation (ON and OFF) of the air charging device 1. The plurality of control buttons 13 are operable to set the predetermined charging level or other air charging or inflation settings for the control circuit 10.

Further, the air charging device 1 comprises a pressure relief device 14 connected to the air outlet port 11. The pressure relief device 14 is similarly in electrical connection with the control circuit 10, and the control circuit 10 is operable to control activation or de-activation of the pressure relief device 14.

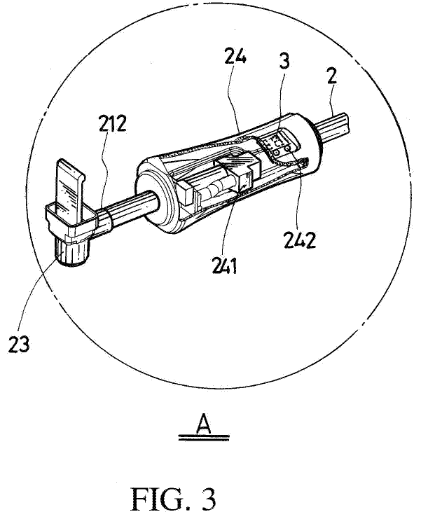

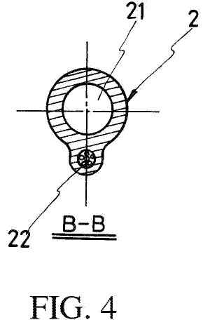

The air charging pipeline 2 comprises an air conveyance channel 21 and a first signal transmission line 22. For example, the air conveyance channel 21 and the first signal transmission line 22 can be jointly housed in an enclosure made of a plastic material to form a unitarily-structured air charging pipeline 2 (as shown in FIG. 4). The air conveyance channel 21 has an end that is provided with an air entrance end 211 and an opposite end that is provided with an air charging end 212. The air entrance end 211 is connectable to and in communication with the air outlet port 11 of the air charging device 1. The air charging end 212 is combined with an air nozzle 23. The air charging pipeline 2 is provided, at a portion thereof adjacent to the air nozzle 23, with a pressure transducer 24 (as shown in FIG. 1). The first signal transmission line 22 is set in electrical connection with the pressure transducer 24 and the control circuit 10, so that data of detection acquired with the pressure transducer 24 is transmitted through the first signal transmission line 22 to the control circuit 10. Further, the pressure transducer 24 is provided, in an interior thereof, with a pressure transducer module 241 and is also provided, on an outside surface thereof, with a plurality of setting buttons 242 (as shown in FIG. 3). The pressure transducer module 241 and the plurality of setting buttons 242 are set in electrical connection the control circuit 10 through the first signal transmission line 22. The pressure transducer module 241 is operable to detect an internal pneumatic pressure of at least one inflatable object, and data of detection is transmitted through the first signal transmission line 22 to the control circuit 10. Further, the plurality of setting buttons 242 that are provided on the pressure transducer 24 are operable to directly make and control settings of the control circuit 10.

The display device 3 is arranged at a location on the air charging device 1 (as shown in FIG. 1) and is in electrical connection with the control circuit 10, such that the display device 3 displays the detection data acquired with the pressure transducer 24. Alternatively, the display device 3 can be arranged at a location of being directly mounted on the pressure transducer 24 (as shown in FIG. 3) and is in electrical connection with the pressure transducer module 241, such that the display device 3 displays the data detected by the pressure transducer 24.

The air charging pipeline 2 can be of a linear configuration, or alternatively, the air charging pipeline 2 can be of a curved and resilient (or stretchable) configuration.

The air charging device 1 may further comprise an air supply module 6 (such as an air pump or an air compressor or other types of air charging devices). For example, the air supply module 6 can be directly mounted in an interior of the air charging device 1 (as shown in FIG. 1), and the air supply module 6 is set in electrical connection with the control circuit 10 of the air charging device 1, so that the control circuit 10 is operable to control activation and de-activation (ON and OFF) of the air supply module 6. Further, the air supply module 6 is provided with an air egress terminal that is connected to and in communication with the air outlet port 11, so that air supplied from the air supply module 6 can be fed out through the air outlet port 11. Further, in an alternative example, the air supply module 6 is arranged outside the air charging device 1 and the air supply module 6 is set in electrical connection with the control circuit 10, so that the control circuit 10 is operable to control activation and de-activation of the air supply module 6. Further, the air egress terminal of the air supply module 6 is connected to and in communication with the air outlet port 11, so that pressurized air supplied from the air supply module 6 can be fed out through the air outlet port 11.

It is noted that the control circuit 10 of the air charging device 1 and the pressure transducer 24 are further and respectively provided with wireless signal receiving and transmitting modules that mutually communicate with each other for signal transmission and receiving therebetween, so that an operator may carry out setting of an air charging operation through operating the plurality of setting buttons 242 of the pressure transducer 24, wherein the pressure transducer 24 transmits, in a wireless manner, control signals entered with or made with or generated by the setting button 242 to the control circuit 10 of the air charging device 1 to allow the control circuit 10 to control activation and de-activation of the air supply module 6.

In an example of the present invention, to use the air charging device 1 to carry out an air charging or inflation operation to an inflatable object, the air nozzle 23 of the air charging pipeline 2 is coupled to the inflatable object so that the pressure transducer 24 is disposed adjacent to the inflatable object. Upon activation of the air charging device 1, air or other gas supplied from the air supply module 6 flow, in sequence, through supplies the air outlet port 11, the air conveyance channel 21 of the air charging pipeline 2, and the air nozzle 23 to enter an interior of the inflatable object, and the control circuit 10 of the air charging device 1 is set in electrical connection with the pressure transducer 24 through the first signal transmission line 22 of the air charging pipeline 2 for transmission of signals (such as data signals and power, and other types of signals). Through the pressure transducer 24 being positioned adjacent (very close) to the inflatable object, pressure data detected by the pressure transducer 24 can be close, with better accuracy, to an actual internal pressure of the inflatable object so as to effectively reduce a difference or error between an actual pressure of the inflatable object and the output pressure of the air charging device 1.

The control circuit 10 of air charging device 1 is structured for setting up a predetermined charging level, so that when the internal pressure of the inflatable object to which the pressure transducer 24 is arranged adjacent is detected to be identical to or close to the predetermined charging level of the air charging device 1, the control circuit controls the air supply module 6 to stop the air charging operation and shut down the operation of the air supply module 6, thereby achieving an automatic charging operation that accurately reaches the desired pressure necessary for the inflatable object.

In case that the internal pressure of the inflatable object to which the pressure transducer 24 is arranged adjacent is detected to be less than the predetermined charging level of the air charging device 1, the control circuit 10 controls the air supply module 6 to continue the charging operation until the internal pressure of the inflatable object to which the pressure transducer 24 is arranged adjacent is detected to be identical to or close to the predetermined charging level of the air charging device 1, by which the air supply module 6 is deactivated, thereby achieving an automatic charging operation that accurately reaches the desired pressure necessary for the inflatable object.

In addition, in case that the internal pressure of the inflatable object to which the pressure transducer 24 is arranged adjacent is detected to be greater than the predetermined charging level of the air charging device 1, the control circuit 10 controls the air supply module 6 to stop the air charging operation and activates the pressure relief device 14 to release air or gas from the inflatable object until the internal pressure of the inflatable object to which the pressure transducer 24 is arranged adjacent is detected to be identical to or close to the predetermined charging level of the air charging device 1, by which the operation of the pressure relief device 14 is de-activated, thereby achieving an automatic charging operation that accurately reaches the desired pressure necessary for the inflatable object.

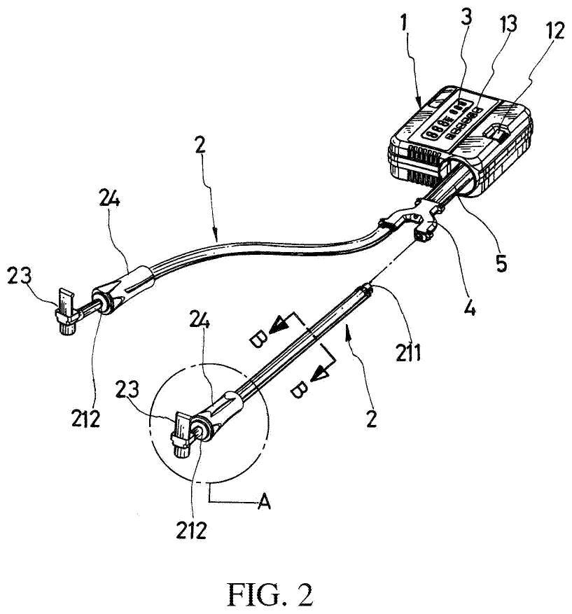

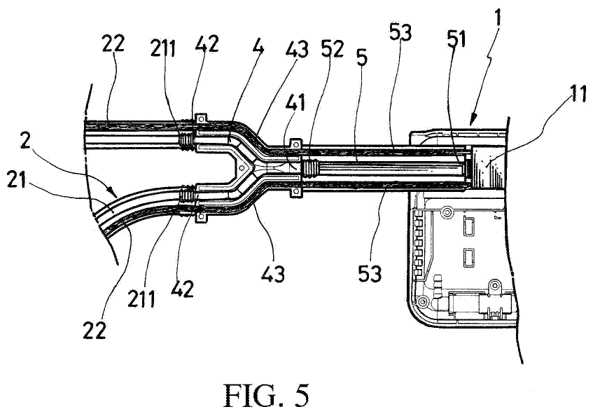

In another example of the present invention (as shown in FIGS. 2 and 5), a branching pipe 4 and an extension pipeline 5 are further provided. The branching pipe 4 has an end that is provided with a first connection end 41 and an opposite end that is provided with at least two or more than two second connection ends 42. Further, the branching pipe 4 is provided with at least one or more than one second signal transmission line 43. In the example shown in FIGS. 2 and 5, the branching pipe 4 is provided with two second signal transmission lines 43. The extension pipeline 5 has an end that is provided with a third connection end 51 and an opposite end that is provided with a fourth connection end 52. Further, the extension pipeline 5 is provided with at least one or more than one third signal transmission line 53. In the example shown in FIGS. 2 and 5, the extension pipeline 5 is provided with two third signal transmission lines 53.

The first connection end 41 of the branching pipe 4 is directly connectable with and in communication with the air outlet port 11 of the air charging device 1 and the two second connection ends 42 are respectively connectable to two air charging pipelines 2 (as shown in FIGS. 2 and 5), meaning the second connection ends 42 are respectively connected to air entrance ends 211 of the air charging pipelines 2 to allow two air conveyance channels 21 of the air charging pipelines 2 to communicate, by way of the branching pipe 4, with the air outlet port 11 of the air charging device 1. The second signal transmission lines 43 of the branching pipe 4 are respectively set in electrical connection with the first signal transmission lines 22 of the air charging pipelines 2 and the control circuit 10 of the air charging device 1 to make the pressure transducers 24 in electrical connection with the control circuit 10 of the air charging device 1, so that with the two second connection ends 42 of the branching pipe 4 being connected to the two air charging pipelines 2, the air charging device 1 is operable to simultaneously carry out air charging to two inflatable objects (such as simultaneously inflating two front wheels or two rear wheels of a vehicle), and pressure data detected by the pressure transducer 24 of one of the air charging pipelines 2 may be closes to an actual internal pressure of the inflatable objects and thus effectively reducing a difference or error between the actual pressure of the inflatable objects and the output pressure of the air charging device 1, thereby achieving an automatic charging operation that accurately and reliably reaches the desired pressure necessary for the inflatable object.

Further, the branching pipe 4 may be further connected by means of the extension pipeline 5 to the air outlet port 11 of the air charging device 1 (as shown in FIG. 5), meaning the first connection end 41 of the branching pipe 4 is connected to and in communication with the fourth connection end 52 of the extension pipeline 5, with the third connection end 51 of the extension pipeline 5 connected to and in communication with the air outlet port 11 of the air charging device 1. The two second connection ends 42 of the branching pipe 4 can be simultaneously and respectively connected to two air charging pipelines 2 so that the air conveyance channels 21 of the air charging pipelines 2 are set in communication, in sequence through the branching pipe 4 and the extension pipeline 5, with the air outlet port 11 of the air charging device 1. Further, the extension pipeline 5 is provided with two third signal transmission lines 53, which are respectively set in electrical connection with the two second signal transmission lines 43 of the branching pipe 4 and the control circuit 10 of the air charging device 1, so that the first signal transmission lines 22 of the air charging pipelines 2 are set, in sequence through the second signal transmission lines 43 and the third signal transmission lines 53, in electrical connection with the control circuit 10 of the air charging device 1.

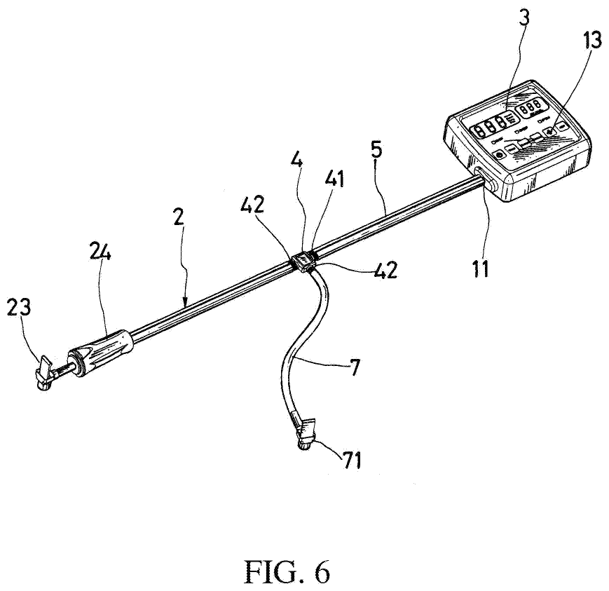

Referring to FIG. 6, at least one auxiliary air charging pipeline 7 is further provided. The auxiliary air charging pipeline 7 is provided with an air charging nozzle 71 (meaning in a configuration of one inlet and one outlet). The air outlet port 11 of the air charging device 1 is connected, through the extension pipeline 5, with the branching pipe 4 (which can be for example a three-way branching pipe having a first connection end 41 and two second connection ends 42), wherein one of the second connection ends 42 of the branching pipe 4 is connected to one air charging pipeline 2 and another one of the second connection ends 42 of the branching pipe 4 is connected to an auxiliary air charging pipeline 7 so that the air charging pipeline 2 and the auxiliary air charging pipelines 7 are in communication with each other. With such an arrangement, by having the branching pipe 4 connected to the air charging pipeline 2 and the auxiliary air charging pipeline 7, the air charging device 1 is operable to simultaneously charge or inflate two inflatable objects, while only using the pressure transducer 24 of the single air charging pipeline 2 to make detection on the two inflatable objects at the same time, so that pressure data detected by the air charging device 1 can be closer to an actual internal pressure of the inflatable objects and thus effectively reducing a difference or error between the actual pressure of the inflatable objects and the output pressure of the air charging device 1, thereby achieving an automatic charging operation that accurately and reliably reaches the desired pressure necessary for the inflatable object.

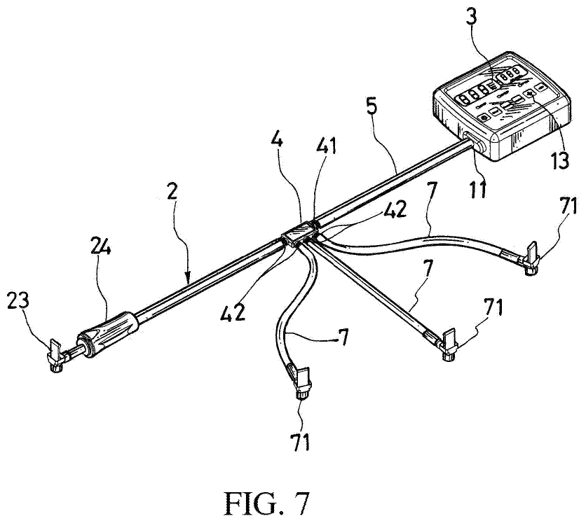

Referring to FIG. 7, three auxiliary air charging pipeline 7 are further provided (meaning in a configuration of one inlet and three outlets). Each of the auxiliary air charging pipelines 7 is provided with an air charging nozzle 71. The air outlet port 11 of the air charging device 1 is connected, through the extension pipeline 5, with the branching pipe 4 (which can be for example a five-way branching pipe having a first connection end 41 and four second connection ends 42), wherein one of the second connection ends 42 of the branching pipe 4 is connected to one air charging pipeline 2 and the remaining three second connection ends 42 of the branching pipe 4 are each connected to one of the auxiliary air charging pipelines 7, so that the single air charging pipeline 2 is set in communication with three auxiliary air charging pipelines 7. With such an arrangement, by having the branching pipe 4 connected to the air charging pipeline 2 and then three auxiliary air charging pipelines 7, the air charging device 1 is operable to simultaneously charge or inflate four inflatable objects, while only using the pressure transducer 24 of the single air charging pipeline 2 to make detection on the four inflatable objects at the same time, so that pressure data detected by the air charging device 1 can be closer to an actual internal pressure of the inflatable objects and thus effectively reducing a difference or error between the actual pressure of the inflatable objects and the output pressure of the air charging device 1, thereby achieving an automatic charging operation that accurately and reliably reaches the desired pressure necessary for the inflatable object.

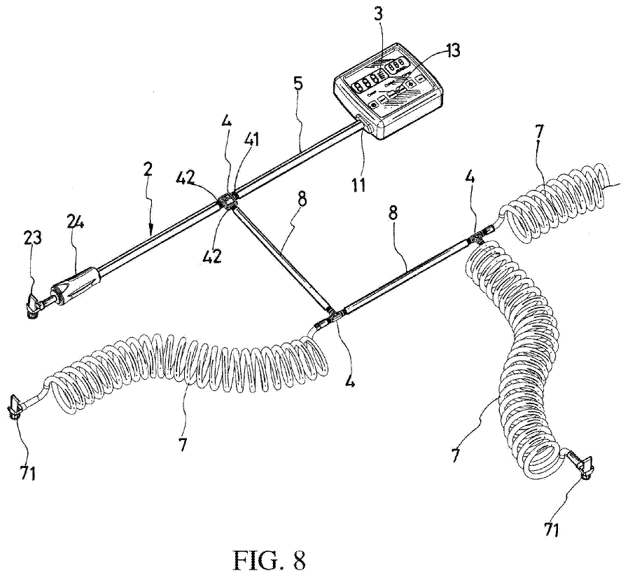

Referring to FIG. 8, a plurality of branching pipe 4, a plurality of auxiliary air charging pipelines 7, and a plurality of connection pipelines 8 are further provided. Each of the auxiliary air charging pipelines 7 is provided with an air charging nozzle 71. The air outlet port 11 of the air charging device 1 is connected, through the extension pipeline 5, to one branching pipe 4 (which can be for example a three-way branching pipe having a first connection end 41 and two second connection ends 42), and the second connection ends 42 of the branching pipe 4 that is connected with the extension pipeline 5 are respectively connected to air charging pipeline 2 and one connection pipeline 8. The connection pipeline 8 that is adjacent to and connected with the air charging pipeline 2 is further connected with at least two branching pipes 4 (which can each be for example a three-way branching pipe having a first connection end 41 and two second connection ends 42) and an additional connection pipeline 8, for expanding connection with three auxiliary air charging pipelines 7, so that the three auxiliary air charging pipelines 7 are made in communication with the air charging pipeline 2. With such an arrangement, the plurality of branching pipe 4 and the plurality of the connection pipelines 8 are arranged to connect the air charging pipeline 2 and the plurality of auxiliary air charging pipelines 7, the air charging device 1 is operable to simultaneously charge or inflate four inflatable objects, while only using the pressure transducer 24 of the single air charging pipeline 2 to make detection on the four inflatable objects at the same time, so that pressure data detected by the air charging device 1 can be closer to an actual internal pressure of the inflatable objects and thus effectively reducing a difference or error between the actual pressure of the inflatable objects and the output pressure of the air charging device 1, thereby achieving an automatic charging operation that accurately and reliably reaches the desired pressure necessary for the inflatable object.

The auxiliary air charging pipelines 7 can be of a linear configuration, or alternatively, the auxiliary air charging pipelines 7 can be of a curved and resilient (or stretchable) configuration.

Thus, the technical features of the present invention are that the air charging pipeline 2 is provided, on a portion thereof that is adjacent to an inflatable object, with a pressure transducer 24, and the air charging pipeline 2 is provided with an air conveyance channel 21 and a first signal transmission line 22, so that the air charging pipeline 2 is connectable and thus in communication with the air charging device 1 by means of the air conveyance channel 21 and is set in electrical connection with the pressure transducer 24 and the control circuit 10 arranged in the air charging device 1 by means of the first signal transmission line 22 to form electrical connection between the pressure transducer 24 and the control circuit 10. With such an arrangement, by having the pressure transducer 24 arranged at a location that is adjacent to (or close to) an inflatable object, pressure data detected by the pressure transducer 24 is closer to an actual internal pressure of the inflatable object, and thus effectively reducing a difference or error between the actual pressure of the inflatable object and the output pressure of the air charging device 1. Further, the operation of the air charging device 1 can be shut down when the pressure transducer 24 detects the internal pressure of the inflatable object adjacent thereto being identical to a predetermined charging level of the air charging device 1, thereby achieving an automatic charging operation that accurately and reliably reaches the desired pressure necessary for the inflatable object.

I claim:

1. An inflation device featuring automatic pressure detecting, air charging, and pressure releasing, comprising:
an air charging device, which is provided with an air outlet port, the air charging device being provided, in an interior thereof, with a control circuit, the control circuit being operable to set up a predetermined charging level and to receive a signal transmitted from a pressure transducer; and
at least one air charging pipeline, which comprises an air conveyance channel and a first signal transmission line, the air conveyance channel having an end that is provided with an air entrance end and an opposite end that is provided with an air charging end, the air entrance end being in communication with the air outlet port, the air charging end being combined with an air nozzle, the air charging pipeline being provided, at a portion thereof adjacent to the air nozzle, with the pressure transducer, the first signal transmission line being in electrical connection with the pressure transducer and the control circuit to form electrical connection between the pressure transducer and the control circuit;
wherein the air nozzle is adapted to connect with an inflatable object such that an operation of the air charging device is de-activated in a condition that an internal pressure of the inflatable object to which the pressure transducer is positioned adjacent detected by the pressure transducer is identical to the predetermined charging level.

2. The inflation device featuring automatic pressure detecting, air charging, and pressure releasing according to claim 1, wherein the air outlet port is connected with a pressure relief device, the pressure relief device being in electrical connection with the control circuit so as to allow the control circuit to control activation/de-activation of the pressure relief device.

3. The inflation device featuring automatic pressure detecting, air charging, and pressure releasing according to claim 1, further comprising an air supply module, wherein the air supply module is arranged in an interior of the air charging device and the air supply module is in electrical connection with the control circuit so as to allow the control circuit to control activation/de-activation of the air supply module, the air supply module having an air egress terminal connectable to and in communication with the air outlet port to allow air supplied from the air supply module to be fed out through the air outlet port.

4. The inflation device featuring automatic pressure detecting, air charging, and pressure releasing according to claim 1, wherein the air charging device comprises an air supply module, the air supply module being arranged outside the air charging device, the air supply module being in electrical connection with the control circuit so as to allow the control circuit to control activation/de-activation of the air supply module, the air supply module having an air egress terminal connectable to and in communication with the air outlet port to allow air supplied from the air supply module to be fed out through the air outlet port.

5. The inflation device featuring automatic pressure detecting, air charging, and pressure releasing according to claim 1 further comprising a display device, wherein the display device is operable to display data detected by the pressure transducer, the display device being arranged on the air charging device and in electrical connection with the control circuit, the air charging device being provided with a plurality of control buttons, which are in electrical connection with the control circuit, the control buttons being operable to set control of air charging.

6. The inflation device featuring automatic pressure detecting, air charging, and pressure releasing according to claim 1, further comprising a display device, wherein the display device is operable to display data detected by the pressure transducer, the display device being arranged on the pressure transducer and in electrical connection with the control circuit, the pressure transducer being provided, on an outside surface thereof, with a plurality of setting buttons, which are in electrical connection with the control circuit to control setting of the control circuit.

7. The inflation device featuring automatic pressure detecting, air charging, and pressure releasing according to claim 1, wherein the control circuit and the pressure transducer are respectively provided with wireless signal receiving and transmitting modules that are in communication with each other for mutual transmission with each other, the pressure transducer being provided with a plurality of setting buttons, which are operable for setting control of air charging, the pressure transducer being operable to transmit, in a wireless manner, control signals from the setting buttons to the air charging device.

8. The inflation device featuring automatic pressure detecting, air charging, and pressure releasing according to claim 1 further comprising a branching pipe, wherein the branching pipe comprises a first connection end and at least two second connection ends, the branching pipe comprising at least two second signal transmission lines, the first connection end being directly connectable with the air outlet port, the two second connection ends being respectively and simultaneously connectable with air entrance ends of two air charging pipelines, the two second signal transmission lines being respectively set in electrical connection with first signal transmission lines of the two air charging pipelines and the control circuit to form electrical connection between the pressure transducers and the control circuits.

9. The inflation device featuring automatic pressure detecting, air charging, and pressure releasing according to claim 1 further comprising a branching pipe and an extension pipeline, wherein the branching pipe comprises a first connection end and at least two second connection ends, the branching pipe comprising at least two second signal transmission lines, the extension pipeline having one end that is provided with a third connection end and an opposite end that is provided with a fourth connection end, the extension pipeline being provided with at least two third signal transmission lines, the first connection end being connected to and in communication with the fourth connection end, the third connection end being connected to and in communication with the air outlet port, the two second connection ends being respectively and simultaneously connected with air entrance ends of two air charging pipelines, the two second signal transmission lines being respectively set in electrical connection with the first signal transmission lines of the two air charging pipelines, the two third signal transmission lines being respectively set in electrical connection with the two second signal transmission lines and the control circuit electrical connection, so that the first signal transmission lines are set, through the second signal transmission lines and the third signal transmission lines in sequence, in electrical connection with the control circuit.

10. The inflation device featuring automatic pressure detecting, air charging, and pressure releasing according to claim 1 further comprising a branching pipe and at least one auxiliary air charging pipeline, the branching pipe comprising a first connection end and at least two second connection ends and also comprising at least one second signal transmission line, the auxiliary air charging pipeline being provided with an air charging nozzle, the air outlet port being connected with the first connection end, one of the second connection ends being connected with the air charging pipeline, another one of the second connection ends being connected with the auxiliary air charging pipeline, so that the air charging pipeline, the auxiliary air charging pipelines and the air outlet port are in communication with each other, the second signal transmission line being in electrical connection with the first signal transmission line of the air charging pipeline and the control circuit to form electrical connection between the pressure transducer and the control circuit.

11. The inflation device featuring automatic pressure detecting, air charging, and pressure releasing according to claim 1 further comprising a branching pipe and three auxiliary air charging pipelines, the branching pipe comprising a first connection end and at least four second connection ends and also comprising at least one second signal transmission line, the auxiliary air charging pipelines being provided with an air charging nozzle, the air outlet port being connected with the first connection end, one of the second connection ends being connected with the air charging pipeline, remaining three ones of the second connection ends being respectively connected with the auxiliary air charging pipelines, so that the air charging pipeline, the auxiliary air charging pipelines, and the air outlet port are in communication with each other, the second signal transmission line being in electrical connection with the first signal transmission of line the air charging pipeline and the control circuit to form electrical connection between the pressure transducer and the control circuit.

12. The inflation device featuring automatic pressure detecting, air charging, and pressure releasing according to claim 1 further comprising a plurality of branching pipes, a plurality of auxiliary air charging pipelines, and a plurality of connection pipelines, the branching pipes being provided with a first connection end and at least two second connection ends and being also provided with at least one second signal transmission line, the auxiliary air charging pipelines being provided with an air charging nozzle, the air outlet port being connected with the first connection end of one of the branching pipes, the one of the branching pipes that is connected with the air outlet port being such that the two second connection ends thereof are respectively connected with the air charging pipeline and one of the connection pipelines, the connection pipeline that is connected with and located adjacent to the air charging pipeline being further connected with at least two branching pipes, one connection pipelines, and three auxiliary air charging pipelines to form communication between the auxiliary air charging pipelines and the air charging pipeline.

13. The inflation device featuring automatic pressure detecting, air charging, and pressure releasing according to claim 1, wherein the air charging pipeline is of a linear configuration.

14. The inflation device featuring automatic pressure detecting, air charging, and pressure releasing according to claim 1, wherein the air charging pipeline is of a curved and elastically stretchable configuration.

15. The inflation device featuring automatic pressure detecting, air charging, and pressure releasing according to claim 10, wherein the auxiliary air charging pipeline is of a linear configuration.

16. The inflation device featuring automatic pressure detecting, air charging, and pressure releasing according to claim 11, wherein the auxiliary air charging pipelines are of a linear configuration.

17. The inflation device featuring automatic pressure detecting, air charging, and pressure releasing according to claim 12, wherein the auxiliary air charging pipelines are of a linear configuration.

18. The inflation device featuring automatic pressure detecting, air charging, and pressure releasing according to claim 10, wherein the auxiliary air charging pipeline is of a curved and elastically stretchable configuration.

19. The inflation device featuring automatic pressure detecting, air charging, and pressure releasing according to claim 11, wherein the auxiliary air charging pipelines are of a curved and elastically stretchable configuration.

20. The inflation device featuring automatic pressure detecting, air charging, and pressure releasing according to claim 12, wherein the auxiliary air charging pipelines are of a curved and elastically stretchable configuration.
